(19) United States
(12) Patent Application Publication
(10) Pub. No.: US 2016/0112799 A1
(43) Pub. Date: Apr. 21, 2016

(54) ACOUSTIC SYSTEM, ACOUSTIC SYSTEM CONTROL DEVICE, AND ACOUSTIC SYSTEM CONTROL METHOD

(71) Applicant: YAMAHA CORPORATION, Hamamatsu-shi (JP)

(72) Inventors: Haruki UEHARA, Hamamatsu-shi (JP); Katsuaki TANAKA, Hamamatsu-shi (JP); Akihiko SUYAMA, Hamamatsu-shi (JP)

(21) Appl. No.: 14/885,167

(22) Filed: Oct. 16, 2015

(30) Foreign Application Priority Data
Oct. 17, 2014 (JP) 2014-213219
Aug. 19, 2015 (JP) 2015-161606

(51) Int. Cl. H04R 3/12; H04H 60/04; H04R 29/00; H04R 3/04

(52) U.S. Cl. CPC H04R 3/12; H04R 3/04; H04H 60/04; H04R 29/001; H04R 2420/01; H04R 2420/03

(57) ABSTRACT

An acoustic system includes a supply device, which is connected to a network and configured to supply an acoustic signal to the network and at least one output device configured to output a sound that is based on the acoustic signal supplied from the supply device via the network. The acoustic system also includes a detection unit configured to detect whether the at least one output device is in a state of being capable of outputting the sound and a control device configured to control, based on a result of the detection by the detection unit, to which output device the acoustic signal is to be supplied out of the at least one output device.

### CROSS-REFERENCE TO RELATED APPLICATION

The present application claims priority from Japanese Applications JP 2014-213219 and JP 2015-161606, the content of which is hereby incorporated by reference into this application.

### BACKGROUND OF THE INVENTION

1. Field of the Invention

One or more embodiments of the invention disclosed in this patent application relates to a technology for controlling a device configured to output an acoustic signal in a network to which a musical instrument and the like are connected.

2. Description of the Related Art

Hitherto, there has been an acoustic system configured to transmit, among others, music data (music playing event data such as MIDI data) and an acoustic signal (audio signal), or control data thereof (MIDI control data and acoustic control data) over a network that is built in compliance with a given communication standard (for example, a TCP/IP standard) (see Japanese Patent Application Laid-open No. 2005-64880, for example). In this acoustic system, a plurality of nodes, for example, a control device such as a personal computer and various output devices (an electronic piano, a speaker device, and the like), are connected via the network so that the plurality of output devices play music or the like in sync.

Some of the output devices are equipped with a soundboard vibration device, which is a soundboard with a vibrator mounted thereto (e.g., Japanese Patent Application Laid-open No. 2013-77002). For example, in Japanese Patent Application Laid-open No. 2013-77002, there is described an electric piano capable of generating a rich sound by vibrating the soundboard with the vibrator in a manner determined by acoustic signals.

### SUMMARY OF THE INVENTION

Examples of speaker devices include, in addition to a full-range type capable of outputting sounds from bass to high range, woofers, which output bass sounds, a mid-range type, which outputs middle range sounds, and tweeters, which output high range sounds. With the soundboard vibration device, the sound quality is dependent on the frequency characteristics of an acoustic signal supplied to the vibrator, which vibrates the soundboard, because the shape and the like of the soundboard vary from one instrument type to another. For instance, at some frequencies of the acoustic signal supplied to the vibrator, there is a chance that a desired sound is not emitted from the soundboard, or that an unintended sound is emitted from the soundboard.

It is common for output devices that include a soundboard vibration device to have, in addition to a mode in which sound is emitted by vibrating the soundboard, a mode in which the output device is used as a normal musical instrument, namely, a mode in which the vibrator of the soundboard vibration device is not put into operation and an electronic sound of a piano or a sound generated by the stroke of a string is emitted as played by the player. Output devices of this type do not need to be supplied with acoustic signals in the mode where the soundboard vibration device is not put into operation. An acoustic system that makes a more appropriate choice when selecting an output device to use based on a tune to be played and the state of output devices is therefore waited for.

One or more embodiments of the invention disclosed in this patent application is proposed in view of the problem described above, and an object of one or more embodiments of the present invention is to provide an acoustic system capable of switching from one of output devices connected to a network to another as a destination to which an acoustic signal is supplied.

In one or more embodiments of the present invention, an acoustic system includes a supply device, which is connected to a network and configured to supply an acoustic signal to the network and at least one output device configured to output a sound that is based on the acoustic signal supplied from the supply device via the network. The acoustic system also includes a detection unit configured to detect whether the at least one output device is in a state of being capable of outputting the sound and a control device configured to control, based on a result of the detection by the detection unit, to which output device the acoustic signal is to be supplied out of the at least one output device.

In one or more embodiments of the present invention, an acoustic system control device includes an acoustic signal obtaining unit configured to obtain an acoustic signal and an optimum frequency characteristics obtaining unit configured to obtain, from each of a plurality of output devices each configured to output a sound based on the acoustic signal, optimum frequency characteristics of the each of a plurality of output devices. The acoustic system control device also includes an output feasibility information obtaining unit configured to obtain output feasibility information, which indicates whether or not at least one of the plurality of output devices is in a state of being capable of outputting the sound, and a selection unit configured to select, from among the plurality of output devices, based on the acoustic signal, the optimum frequency characteristics, and the output feasibility information, at least one output device to which the acoustic signal is to be output.

In one or more embodiments of the present invention, an acoustic system control method includes supplying an acoustic signal to the network by a supply device, which is connected to a network, and outputting a sound that is based on the acoustic signal supplied from the supply device via the network by at least one output device. The acoustic system control method also includes detecting whether the at least one output device is in a state of being capable of outputting the sound by a detection unit and controlling, based on a result of the detection by the detection unit, to which output device the acoustic signal is to be supplied out of the at least one output device, by a control device.

### BRIEF DESCRIPTION OF THE DRAWINGS

FIG. 1 is a block diagram for illustrating the configuration of an acoustic system according to an embodiment of the present invention.

FIG. 2 is a block diagram for illustrating the configuration of a TA piano.

FIG. 3 is a block diagram for illustrating the configuration of a TA guitar system.

FIG. 4 is a flow chart for illustrating the processing specifics of music data reproduction operation.

FIG. 5 is a flow chart for illustrating the processing specifics of the music data reproduction operation.

FIG. 6 is a block diagram for illustrating the configuration of an acoustic system according to another embodiment of the present invention.

FIG. 7 is a block diagram for illustrating the configuration of an acoustic system according to still another embodiment of the present invention.

FIG. 8 is a block diagram for illustrating the configuration of an acoustic system according to yet still another embodiment of the present invention.

FIG. 9 is a perspective view of a stand for a trumpet.

FIG. 10 is a schematic diagram for illustrating the internal structure of the stand for a trumpet.

FIG. 11 is a perspective view of the stand with a trumpet put thereon.

FIG. 12 is a display screen of a smartphone that is displayed when a change in state is detected.

FIG. 13 is a display screen of the smartphone that is used to switch sound generators.

### DETAILED DESCRIPTION OF THE INVENTION

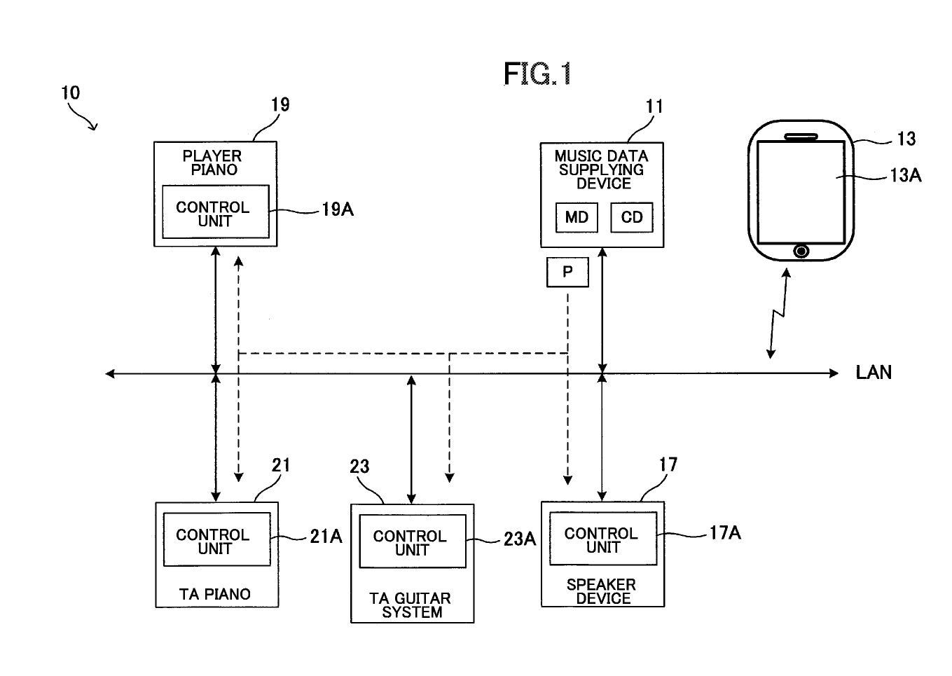

Embodiments of the present invention are described below with reference to the accompanying drawings. FIG. 1 is a diagram of an acoustic system 10 according to an embodiment of the invention of this patent application. The acoustic system 10 includes a music data supplying device 11, a smartphone 13, a speaker device 17, a player piano 19, a TA piano 21, and a TA guitar system 23, which are connected to one another via a local area network (LAN).

The music data supplying device 11 is, for example, external storage that can be connected to a LAN, such as network-attached storage (NAS). The music data supplying device 11 stores, for example, signals such as music data MD, which is created by sampling a tune that is in the form of analog signals, and control data CD in which a music playing event such as MIDI data is set. The music data supplying device 11 is not limited to NAS, and can be other types of storage (a server or the like) that are capable of supplying the signals described above (the music data MD (audio signals) and music playing performance data (acoustic signals converted from music playing event data such as MIDI data)) to a network. The file format of the music data MD is not particularly limited, and can be, for example, MP3, WAVE, WMA, AAC, M4A, or FLAC.

The acoustic system 10 of this embodiment uses a given communication standard, for example, a communication standard that is compliant with a TCP/IP standard, to transmit a packet P over the LAN. The music data supplying device 11 converts the music data MD or the control data CD into the packet P, and transmits the packet P to the other devices of the acoustic system 10. The acoustic system 10 may employ a communication standard (network protocol) that uses an isochronous transmission method in order to implement this form of data exchange using packets. The acoustic system 10 is capable of controlling the devices to which the music data MD saved on the music data supplying device 11 is supplied, based on the specifics of the music data MD.

The communication standard used to transmit the packet P can be changed as seen fit. For instance, the communication standard used can be one for building a home network to which a plurality of electronic devices including home appliances, portable terminals, and personal computers are connected, such as the Digital Living Network Alliance (DLNA) (trademark). Another example is a communication standard that is used in a digital audio network such as the CobraNet (trademark). The network included in the acoustic system 10 can accordingly employ various communication modes of any network that is capable of transmitting acoustic signals (the music data MD and the like).

The smartphone 13 holds communication to and from an access point connected to the LAN by wireless communication that is compliant with IEEE 802.11, for example. The smartphone 13 includes, for example, a plurality of central processing units (CPUs), a memory, which stores programs executed by the respective CPUs, a RAM on which data is temporarily stored when the CPUs execute their respective programs, and an internal bus, which connects those devices to one another (the components are not shown). An application designed to control the acoustic system 10 in a centralized manner is installed in the smartphone 13. Various programs of this application are executed by the CPUs to implement various functions of the smartphone 13. The various functions of the smartphone 13 include, for example, obtaining the titles of tunes in the music data MD saved on the music data supplying device 11, creating a playlist, and displaying the playlist on a touch panel 13A.

The speaker device 17 includes a control unit 17A, which can be controlled by the application of the smartphone 13. The control unit 17A receives the packet P of the music data MD from the music data supplying device 11 via the LAN, and converts the packet P into analog audio signals. The speaker device 17 uses a built-in amplifier to amplify the analog audio signals, and emits the amplified sound. The smartphone 13 can control the control unit 17A in determining whether to obtain the music data MD from the music data supplying device 11. The smartphone 13 accordingly controls whether or not the speaker device 17 reproduces the music data MD by controlling the control unit 17A. The control unit 17A is not limited to a device built in the speaker device 17, and may be a separate device detachable from the speaker device 17. For example, the control unit 17A may be a device externally connectable to the speaker device 17 which includes, in addition to a connector to which a LAN cable is connected, a connector to which an acoustic cable for connection to the speaker device 17 is connected.

The player piano 19 is a device that plays music automatically by operating keys and pedals based on the control data CD (music playing performance data or the like), which is supplied from the music data supplying device 11. In addition to playing music automatically, the player piano 19 receives with a control unit 19A the music data MD supplied from the music data supplying device 11, amplifies the received data with a built-in amplifier, and emits the amplified sound from a speaker unit (not shown). Similarly to the speaker device 17, whether or not the player piano 19 reproduces the music data MD is controlled by the smartphone 13 by controlling the control unit 19A.

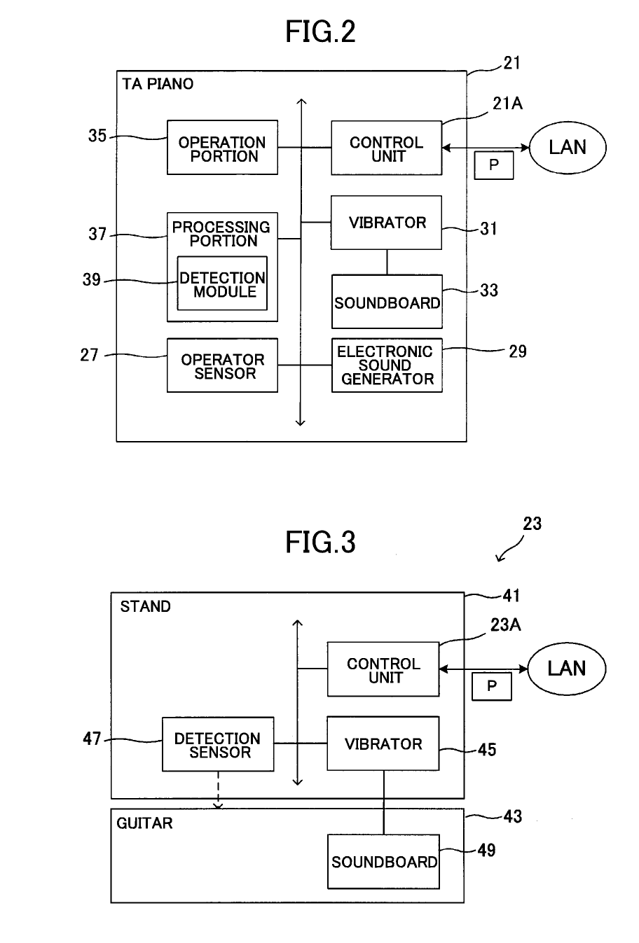

The TA piano 21 is a device that reproduces the music data MD with the use of the TransAcoustic (trademark) technology. The TA piano 21 has an exterior appearance of a normal grand piano or upright piano, and is put in a suitable place. The TA piano 21 is similar to common electronic pianos in that, in addition to an operator sensor 27, which detects the operation of music play operators (keys, hammers, pedals, and the like), and an electronic sound generator 29, which generates signals of an electronic sound by analyzing detection signals of the operator sensor 27, a control unit 21A, a vibrator 31, a soundboard 33, an operation portion 35, and a processing portion 37 are included as illustrated in FIG. 2. What is illustrated in FIG. 2 is a part of the configuration of the TA piano 21. The control unit 21A receives the packet P of the music data MD from the music data supplying device 11, and converts the received data into drive signals for the vibrator 31. The processing portion 37 includes a processing circuit such as a CPU, and controls whether or not the control unit 21A converts the music data MD and whether or not the drive signals are supplied to the vibrator 31 both. The vibrator 31 is mounted to the soundboard 33 and vibrates in a manner that is determined by the amplitude or frequency of the waveform of the supplied drive signals, thereby vibrating the soundboard 33 and causing the soundboard 33 to emit sound. The drive signals for the vibrator 31 which are created through conversion and output by the control unit 21A may be the same as the analog audio signals created through conversion and output by the control unit 17A of the speaker device 17.

The operation portion 35 is a device that has an input/output function of the TA piano 21, and includes a display portion and operation switches among others. The processing portion 37 switches the TA piano 21 from one mode to another out of, for example, three modes, depending on the specifics of operation performed by a user on the operation portion 35. A first mode is a normal mode in which a player hits keys and thereby operates the hammers so that sound is generated solely through the stroke of a string by a hammer as in a common grand piano. A second mode is a TA mode in which the stroke of a string by a hammer is prohibited and the soundboard 33 is vibrated by the vibrator 31 in a manner that is determined by the music data MD supplied by the music data supplying device 11, or in a manner that is determined by electronic sound signals generated by the electronic sound generator 29 from the playing of the TA piano 21 itself by a player. The TA piano 21 in the TA mode can switch, for example, between the music data MD and electronic sound signals generated by playing the TA piano 21 as signals on which drive signals supplied to the vibrator 31 are based. A third mode is a combination mode in which sound is generated by the stroke of a string as in the normal mode and the soundboard 33 is also vibrated by the vibrator 31.

A detection module 39 of the processing portion 37 determines whether or not the TA piano 21 is in a state where sound can be emitted from the soundboard 33 by operating the vibrator 31 based on the music data MD. This processing by the detection module 39 is implemented by, for example, the CPU of the processing portion 37 by executing a corresponding program. The vibrator 31 operates in, for example, the second mode and the third mode out of the three modes described above. In other words, the music data MD for operating the vibrator 31 is unnecessary in the first mode. The detection module 39 determines whether or not the music data MD is necessary in response to the setting or switching of a mode, and notifies the smartphone 13 of the determination via the LAN. The smartphone 13 controls the control unit 21A based on the notification from the detection module 39 to change settings about whether or not the control unit 21A is to obtain the music data MD from the music data supplying device 11. When the TA piano 21 is in the first mode, for example, the smartphone 13 stops the control unit 21A from executing processing of obtaining the packet P that corresponds to the music data MD.

The method of detection by the detection module 39 is not limited to the determination based on the current mode of the TA piano 21. For instance, the detection module 39 may determine that the music data MD is unnecessary when the operation switches of the operation portion 35 are operated to power off the TA piano 21, then notifying the smartphone 13 of the determination. Similarly to the TA piano 21, the speaker device 17 and the player piano 19 may each include a detection module that detects whether or not the device is in a state where the music data MD can be received and reproduced (a power on state or the like).

The TA guitar system 23 is a device that reproduces the music data MD with the use of the TransAcoustic (trademark) technology. The TA guitar system. 23 includes, as illustrated in FIG. 3, a guitar 43, which has an exterior appearance of an acoustic guitar, and a stand 41 on which the guitar 43 is set, and is set up in a suitable place. The stand 41 is provided with, in addition to a control unit 23A, a vibrator 45 and a detection sensor 47. The control unit 23A converts the packet P that corresponds to the music data MD and that is received from the music data supplying device 11 into drive signals that are supplied to the vibrator 45. The vibrator 45 vibrates a soundboard 49 of the guitar 43 put on the stand 41. The vibrator 45 receives a supply of drive signals that reflect the motion of a tune in the music data MD which has been converted by the control unit 23A, to thereby vibrate the soundboard 49 and cause the soundboard 49 to emit sound. The drive signals for the vibrator 45 which are created through conversion and output by the control unit 23A may be the same as the analog audio signals created through conversion and output by the control unit 17A of the speaker device 17.

The detection sensor 47 is a sensor capable of detecting whether or not the guitar 43 is on the stand 41 at the moment. The detection sensor 47 includes a relay switch, which is activated when, for example, the guitar 43 is put in a given place on the stand 41, and a processing circuit, which processes a signal of the relay switch. The detection sensor 47 detects whether the guitar 43 is on the stand 41 or off the stand 41 (because of being used by a user or for other reasons), and notifies the result of the detection to the smartphone 13. Based on the notification from the detection sensor 47, the smartphone 13 controls whether or not the control unit 23A is to obtain the music data MD from the music data supplying device 11. The detection sensor 47 may be other sensors that are capable of detecting the state of the guitar 43 (an infrared sensor or the like).

The thus configured acoustic system 10 of this embodiment switches the output device to which the music data MD saved on the music data supplying device 11 is supplied (one of the speaker device 17, the TA piano 21, the TA guitar system 23, and the player piano 19), based on the specifics of the music data MD. In the case of a piano tune, for example, the acoustic system 10 uses the TA piano 21 or the player piano 19 to reproduce the music data MD, and uses the TA guitar system 23 in the case of a guitar tune. Whether the supplied signals are of a piano tune, a guitar tune, or other types of tune may be detected by performing time analysis on the music data MD itself and determining the type of tune from frequency characteristics, or may be determined from an identifier attached to the tune. In frequency characteristics analysis, for example, a method involving extracting feature points from acoustic signals at given time intervals for comparison or the like, which is described in Japanese Patent Application Laid-open No. 2011-221157, can be employed. Specifically, the frequency characteristics of the music data MD may be analyzed by creating a component matrix in which component values observed on a unit band-by-unit band basis in a unit time are aligned in a time axis direction and a frequency axis direction, creating a phase shift matrix through a phase shift of the component matrix in the time axis direction, calculating a difference between each component value in the component matrix and a corresponding component value in the phase shift matrix, extracting a value that indicates a feature from the calculated difference, and processing the extracted value.

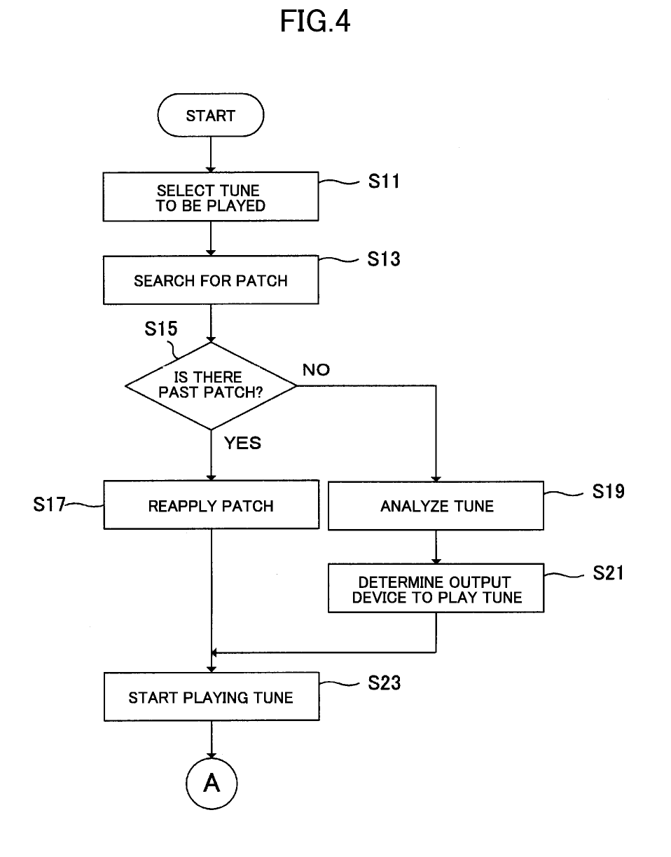

Processing of music data MD reproduction operation by the acoustic system 10 is described next with reference to FIG. 4. First, in Step (hereinafter abbreviated as “S”) 11, that is, in S11 of FIG. 4, the user operates the smartphone 13 to play on the acoustic system 10 a tune of his/her choice out of tunes saved on the music data supplying device 11. When the user selects a tune (a piece of the music data MD) from a playlist (S11), the application of the smartphone 13 searches for a patch that has been set in the past for the title of the selected tune (S13). The “patch” here is a virtual patch for logically setting an arbitrary connection between a plurality of nodes (the speaker device 17, the TA piano 21, and other components) connected via the LAN. The acoustic system 10 transmits the music data MD or the control data CD from an output-side node (the music data supplying device 11) set by the patch to an input-side node (the speaker device 17 or other devices) set by the patch.

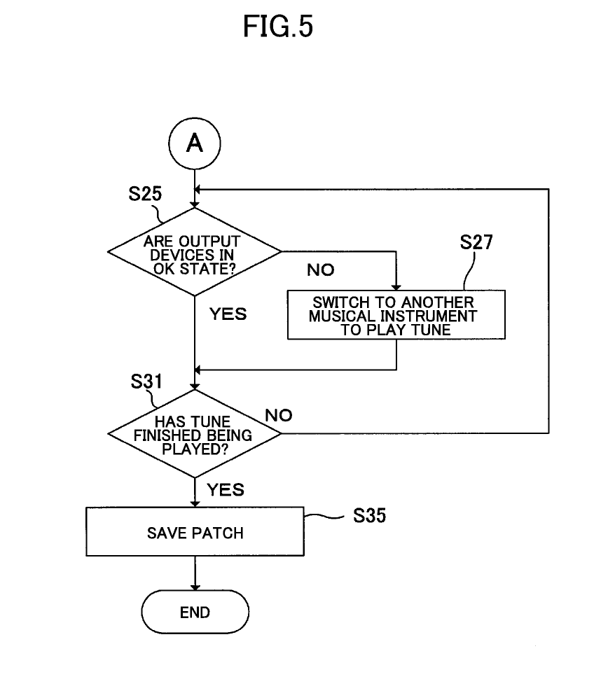

The smartphone 13 includes, for example, a non-volatile memory (flash memory or the like) as storage on which an applied patch is saved. In S35 (see FIG. 5) described later, the smartphone 13 saves information about the piece of the music data MD that has just been reproduced in the flash memory in association with the settings of a patch used to play the tune in the music data MD. The smartphone 13 therefore searches in S13 patches that have been set in the past and saved in the flash memory to determine whether or not the saved patches include one that is associated with the piece of the music data MD selected by the user from the playlist (S15). A patch may be set in advance to a piece of the music data MD saved on the music data supplying device 11. For instance, a patch that chooses the player piano 19 or the TA piano 21 as the output device may be set in advance to the music data MD of a piano tune. The patch determining processing by the smartphone 13 can be omitted in this case.

In the case where a patch that meets the criteria is found (S15: YES), the smartphone 13 reapplies the past patch and starts reproducing the piece of the music data MD selected by the user (S23). In the case where the search does not find a patch that meets the criteria (S15: NO), on the other hand, the smartphone 13 analyzes the selected tune (S19). While various methods can be used for the tune analysis (for example, the method described in Japanese Patent Application Laid-open No. 2011-221157), the description here is given with the analysis of a tune's frequency characteristics in mind. Other possible tune analyzing methods include processing of reading information that is preset by the user tune by tune, and processing of reading a default value that is set in advance to each tune. The sound quality of a musical instrument that uses the TransAcoustic Technology such as the TA piano 21, namely, the quality of a sound that is emitted by vibrating the soundboard 33 with the use of the vibrator 31, depends greatly on the frequency characteristics of the music data MD supplied to the vibrator 31. This is because the soundboard 33 and the soundboard 49, which are components of different types of musical instrument (the TA piano 21 and the TA guitar system 23), are different in shape, material, and the like, and accordingly resonate in different frequency ranges. Among musical instruments that use the TransAcoustic Technology, in what modes the soundboards 33 and 49 vibrate and what sound the soundboards 33 and 49 emit in response to the same music data MD supplied therefore vary from each other depending on the characteristics of the soundboards 33 and 49 with respect to vibration.

For example, in the case where the music data MD that is generated by other sound generators than pianos and ones having a tone timbre similar to that of pianos is supplied to the TA piano 21, the vibrator 31 does not provide vibration that reflects the vibration characteristics of the soundboard 33, which means that the soundboard 33 may not emit a desired sound. The smartphone 13 therefore analyzes the frequency characteristics of a piece of the music data MD selected by the user to choose which output device (out of the speaker device 17, the player piano 19, the TA piano 21, and the TA guitar system 23) is to reproduce the selected piece of the music data MD, and sets this output device as a patch (S21). The smartphone 13 desirably executes processing of making an inquiry to the output devices on the network in advance, for example, before starting S11 (when the application is activated or at other points preceding S11) to obtain, from each output device, information about what frequency characteristics are optimum for the music data MD supplied to the output device.

When the analysis of the piece of the music data MD selected by the user results in the detection of frequency characteristics that are close to those of a piano sound generator, for example, the smartphone 13 chooses the player piano 19 and the TA piano 21 as the output devices to which the music data MD is supplied from the music data supplying device 11 (S21). The control units 19A and 21A of the chosen player piano 19 and TA piano 21 execute processing of obtaining the music data MD from the music data supplying device 11, and the player piano 19 and the TA piano 21 reproduce the music data MD in sync (S23).

When the analysis of the selected piece of the music data MD results in the detection of frequency characteristics that are close to those of a guitar sound generator, for example, the smartphone 13 chooses the TA guitar system 23 as the output device. When the analysis results in the detection of frequency characteristics that belong to none of piano sound generators and guitar sound generators, for example, the smartphone 13 chooses the speaker device 17 as the output device. In this manner, the acoustic system 10 of this embodiment is capable of choosing an output device that is optimum for a piece of the music data MD and reproducing the piece of the music data MD on the optimum output device. After setting a patch in S17 or S21, the smartphone 13 may display the determined patch on the touch panel 13A to prompt the user to make a final decision or change the patch. This enables the user to compare the specific piece of the music data MD and the determined patch so that the piece of the music data MD is reproduced on the output device of his/her choice.

In S25 of FIG. 5, the smartphone 13 determines, for each output device (the TA piano 21 and others), whether the output device is in a state where the music data MD can be reproduced, based on the notification from the detection module 39 or the detection sensor 47 of the output device. In the case where every output device to which the music data MD is supplied is in a fine state with no problems (S25: YES), the smartphone 13 determines whether or not the reproduction of the music data MD has finished (S31). In the case where the reproduction of the music data MD has not been finished yet (S31: NO), the smartphone 13 repeatedly executes S25 and subsequent steps at each given timing. The smartphone 13 thus monitors the state of each output device while the music data MD is being reproduced.

When detecting that at least one of the output devices is in a state where the music data MD cannot be reproduced (S25: NO), the smartphone 13 stops the supply of the music data MD to the output device in a state where the music data MD cannot be reproduced (S27). For example, when detecting from a notification of the detection module 39 that the TA piano 21 has switched from the second mode to the first mode, the smartphone 13 stops the control unit 21A from executing the processing of obtaining the music data MD. When subsequently detecting from a notification of the detection module 39 that the TA piano 21 has switched back to the second mode (S25: NO), the smartphone 13 allows the control unit 21A to resume the processing of obtaining the music data MD (S27). The supply of the music data MD to the TA piano 21 is resumed in this manner.

In S27, in addition to stopping the supply of the music data MD, the smartphone 13 may execute processing of switching the supply destination output device to another output device. For instance, when detecting from a notification of the detection sensor 47 that the guitar 43 is off the stand 41, the smartphone 13 may execute processing of starting the supply of the music data MD to another output device (the speaker device 17 or others) in addition to stopping the supply of the music data MD to the TA guitar system 23. When the described processing including the mid-reproduction detection processing is executed and the reproduction of the music data MD is finished (S31: YES), the smartphone 13 saves the piece of the music data MD that has just been reproduced in association with the applied patch in the flash memory or the like as settings (S35), and ends the whole processing. Saving a patch in the flash memory or the like may be executed not only when the reproduction of a piece of the music data MD is finished but also when any switch between patches takes place (for example, immediately after S27).

The music data MD and the control data CD are examples of acoustic signals. The music data supplying device 11 is an example of a supply device. The speaker device 17, the player piano 19, the TA piano 21, and the TA guitar system 23 are examples of output devices. The smartphone 13 is an example of a control device. The soundboards 33 and 39 are examples of vibrated bodies. The detection module 39 and the detection sensor 47 are examples of detection portions.

The embodiment described above has the following effect:

The detection module 39 of the TA piano 21 determines whether or not the music data MD is necessary in response to the setting or switching of a mode, and notifies the smartphone 13 of the determination. The detection sensor 47 of the TA guitar system 23 detects whether the guitar 43 is on or off the stand 41, and notifies the result of the detection to the smartphone 13. This enables the smartphone 13 to stop the supply of the music data MD and switch the music data supply destination to another output device depending on the state of the TA piano 21 and the TA guitar system 23.

It should be understood that the present invention is not limited to the embodiment described above, and may be subjected to various improvements and modifications without departing from the gist of the present invention.

For example, in the case where a single piece of the music data MD includes a guitar solo part and a piano solo part, the smartphone 13 may make a switch between output devices in time with each solo.

While the embodiment described above deals with a case where one file of the music data MD saved on the music data supplying device 11 is supplied to the output devices, the acoustic system 10 may be configured so that a plurality of related files are simultaneously supplied to optimum output devices. For instance, consider a case where the music data supplying device 11 stores music data MD of guitar tunes and control data CD that can be reproduced together with this music data MD. The smartphone 13 in this case may supply the control data CD to the player piano 19 while supplying the music data MD of guitar tunes to the TA guitar system 23 so that the TA guitar system 23 plays a guitar tune in concert with piano play by the player piano 19.

In the case where a piece of the music data MD that is selected by the user in S11 in the embodiment described above is associated with another piece of the music data MD (a piano part or a guitar part), the smartphone 13 may analyze the frequency characteristics of the pieces of the music data MD to determine the supply destination of each piece of the music data MD separately, and then distribute the pieces of the music data MD concurrently.

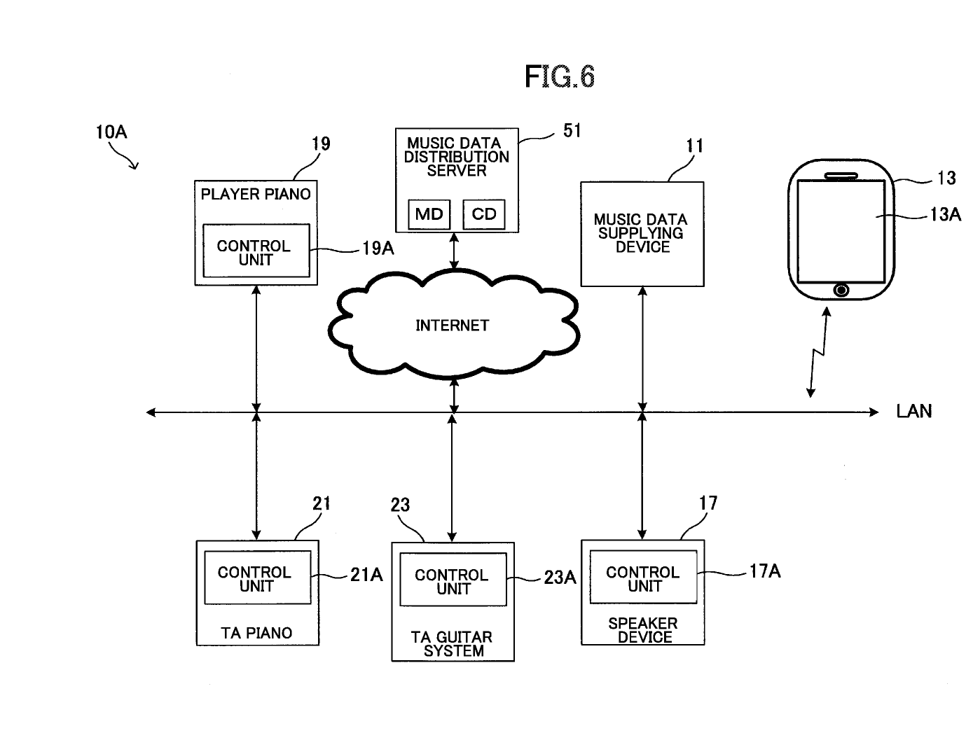

The embodiment described above takes the music data supplying device 11 as an example of a supply device that supplies acoustic signals to a network in this patent application. The supply device, however, is not limited to the music data supplying device 11. For example, a distribution server on the Internet may be employed as the supply device. FIG. 6 is a diagram for illustrating the configuration of an acoustic system 10A according to another embodiment of the present invention. Components of the acoustic system 10A that are similar to those in the embodiment described above are denoted by the same reference symbols, and descriptions thereof are omitted when appropriate. In the acoustic system 10A, the output devices obtain and reproduce the music data MD that is saved on a music data distribution server 51 on the Internet. The music data distribution server 51 is, for example, a server that is provided for public access by a vendor who runs a music distribution business or other entities, and the music data MD can be obtained from the music data distribution server 51 by a given communication standard (the HTTP protocol or the like). For instance, when a user of the acoustic system 10A uses the smartphone 13 to select a desired tune from the music data MD saved on the music data distribution server 51, the smartphone 13 chooses an output device to which the tune is supplied. The control unit (e.g., the control unit 17A) of each chosen output device executes processing of obtaining the piece of the music data MD selected by the user from the music data distribution server 51. The chosen output devices then execute in sync the streaming reproduction of the piece of the music data MD downloaded by their control units (e.g., the control unit 17A).

The thus configured acoustic system 10A is also capable of providing the same effect as that of the acoustic system 10. The acoustic system 10A may save apiece of the music data MD downloaded from the music data distribution server 51 on the music data supplying device 11 or in other places first and then supply the saved piece to each relevant output device from the music data supplying device 11, instead of reproducing the downloaded piece by streaming. The smartphone 13 in this case may execute the downloading of the music data MD from the music data distribution server 51 to the music data supplying device 11.

The smartphone 13 in the embodiment described above may function as a supply device. For example, when the user selects one of a plurality of pieces of the music data MD saved on the smartphone 13, the smartphone 13 may supply the selected piece of the music data MD to each relevant output device. The acoustic system 10 can omit the music data supplying device 11 in this case. The smartphone 13 in this case does not need to control each control unit (e.g., the control unit 17A).

The player piano 19 in the embodiment described above may function as a supply device. For example, in the case where a LAN for a home network is utilized, the player piano 19 that is put in a kid's room may be set as the output side, with the TA piano 21 that is put in the living room set as the input side. In this configuration, audio signals of a sound generated from the playing of the player piano 19 by a player can be transmitted over the LAN to emit the sound from the soundboard 33 of the TA piano 21.

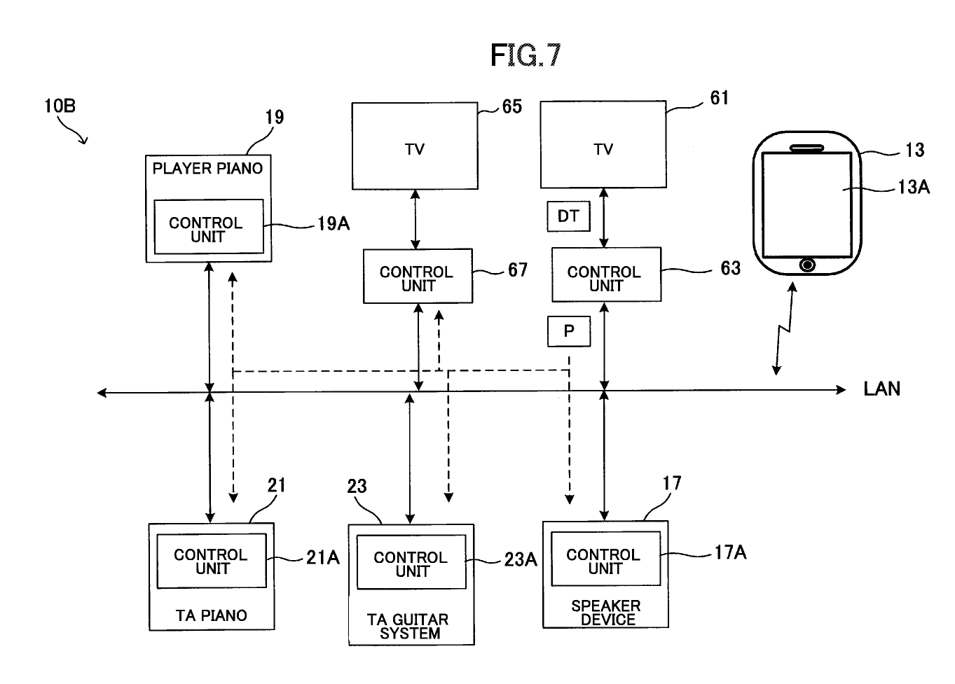

In the embodiment described above, a piece of common audio equipment such as a TV or a radio may function as a supply device. FIG. 7 is a diagram for illustrating the configuration of an acoustic system 10B according to still another embodiment of the present invention. The acoustic system 10B includes a TV 61, which is connected to the LAN via a control unit 63. The control unit 63 is a device that is externally mountable to the TV 61 and that includes, for example, a LAN connector and a connector to which an acoustic cable can be connected. The control unit 63 converts, for example, an analog audio signal DT output from the TV 61 into a digital audio signal through real-time encoding, and supplies the converted signal as the packet P to each relevant output device. The output device to which the packet P is supplied converts the received packet P to reproduce the audio signal DT. The smartphone 13 in this case may determine to which output device the packet P is to be supplied by determining the type of music (a piano tune, a guitar tune, or the like) that is broadcast in a television program in question from, for example, information on listings of digital television broadcast programs.

The acoustic system 10B may include video of the TV 61 as well as audio in the audio signal DT. As illustrated in FIG. 7, in the acoustic system 10B, a TV 65, in addition to the TV 61, is connected to the LAN via a control unit 67. The TV 65 is set up in a room or other places separate from where the TV 61 is installed. The control unit 67 extracts audio and video from the packet P received from the control unit 63, and supplies the extracted audio and video to the TV 65. In the thus configured acoustic system 10B, when the TV 61 receives a television program of a classic concert, for example, audio can be played by the TA piano 21 and the TA guitar system 23 in sync while video is displayed on the TV 65, thereby presenting audio and video with a more realistic sensation to the user.

While the smartphone 13 in the embodiment described above executes the state detection in which the detection module 39 and the detection sensor 47 detect the state of their output devices after the reproduction of the music data MD is started, the state detection may be executed before the reproduction to execute the processing of switching the output destination. Alternatively, the smartphone 13 may execute the detection by the detection module 39 and other similar components and the patch switching before and during the reproduction both.

In the case where a lossless compression file format in which multi-channel (5.1 ch or the like) audio signals can be saved in a single file, such as the FLAC format, is employed as the file format of the music data MD in the embodiment described above, the smartphone 13 may execute control that varies the supply destination output device from one channel to another. The multi-channel may be implemented as a multi-track file having four channels through which signals are output to four speaker devices 17, one channel for signal output to the TA guitar system 23, one channel for signal output to the TA piano 21, and one control channel for signal output to the player piano 19, seven channels in total. The smartphone 13 may vary the supply destination output device from one channel to another also when the data format employed allows the music data MD and the control data CD to be set for each channel separately by dividing the interior of the single packet P into channels as in the CobraNet (trademark).

While the embodiment described above takes the smartphone 13 as an example of the control device, the control device is not limited to the smartphone 13 and may be other portable terminals or a personal computer. The TA guitar system 23, which, in the embodiment described above, has the vibrator 45 that is included in the stand 41, is not limited to this configuration, and the vibrator 45 may be mounted to the guitar 43. The soundboard 49 in this case may be vibrated by sending audio signals through wireless transmission from the control unit 23A of the stand 41 to the vibrator 45 of the guitar 43.

The processing procedures (FIG. 4 and FIG. 5) in the embodiment described above are given as an example, and the order thereof may be changed and steps may be added, deleted, replaced, or otherwise modified as seen fit.

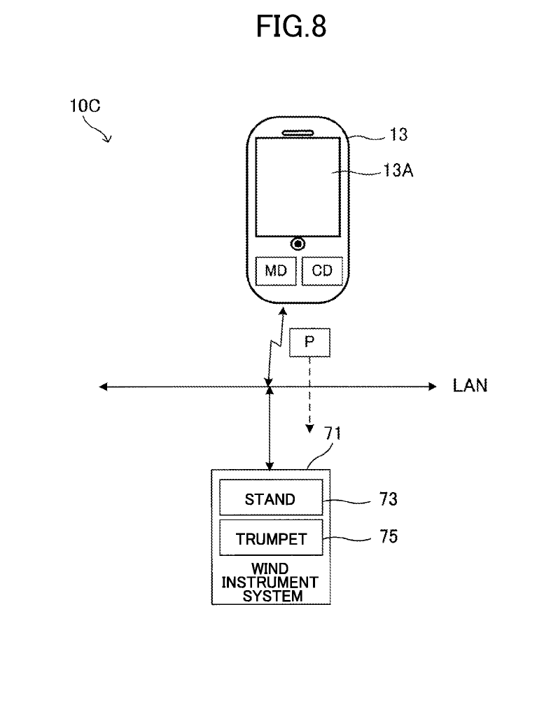

A musical instrument that includes a vibrated body in the invention of this patent application is not limited to musical instruments that respectively include the soundboards 33 and 49 (a piano and a guitar), and may be a wind instrument such as a trumpet or a clarinet, or a percussion instrument such as a drum. FIG. 8 is a diagram for illustrating the configuration of an acoustic system 10C according to yet still another embodiment of the present invention. The acoustic system 10C includes the smartphone 13 and a wind instrument system 71, two of which are connected to a LAN to reproduce with the wind instrument system 71 the music data MD that is stored on the smartphone 13. In the acoustic system 10C, the wind instrument system 71 is thus the only output device connected to the network, and has a one-to-one relationship with the smartphone 13, which functions as the control device and the supply device.

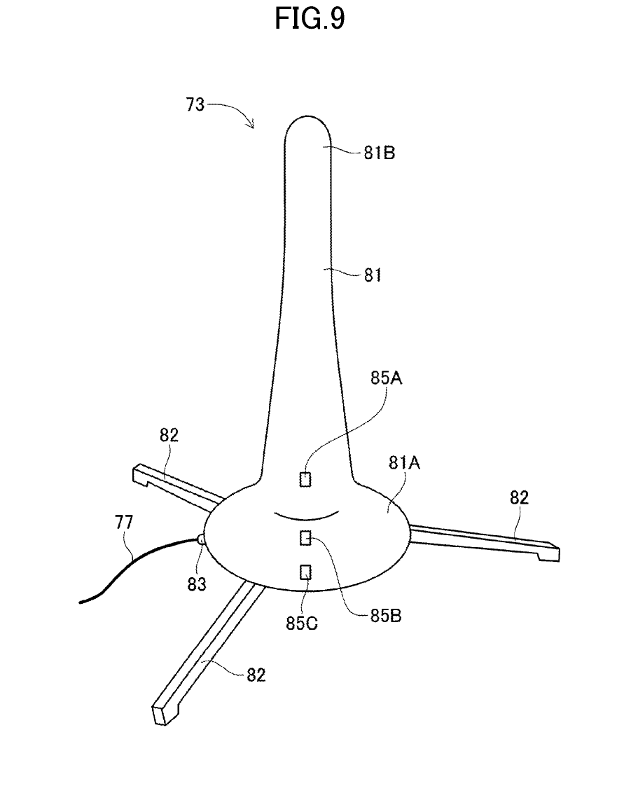

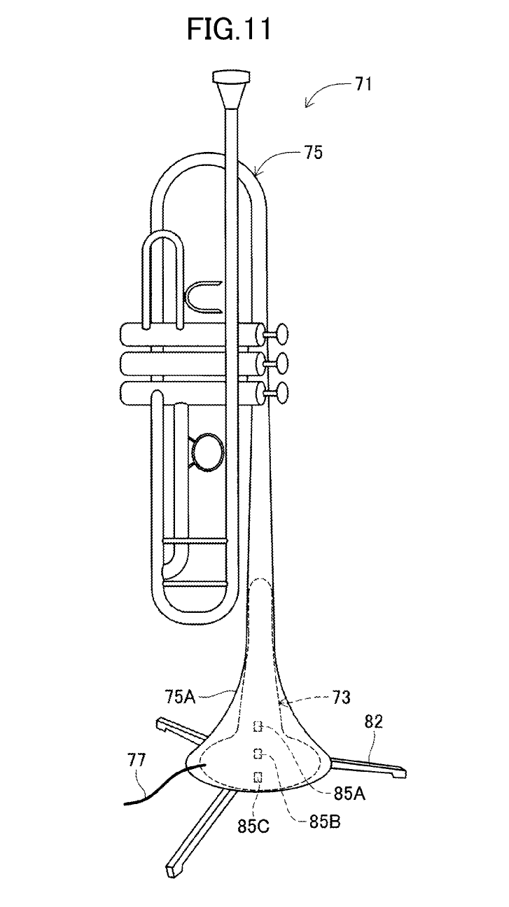

The wind instrument system 71 includes a stand 73 and a wind instrument put on the stand 73, for example, a trumpet 75. FIG. 9 is a perspective view of the stand 73. The stand 73 is structured so as to have three legs 82 under the bottom of a peg portion 81. The peg portion 81 has a substantially conical shape that decreases in diameter from a lower end portion 81A on the legs 82 side toward an upper end portion 81B to follow the shape of a bell 75A (see FIG. 11) of the trumpet 75 put thereon. The lower end portion 81A of the peg portion 81 is provided with an external input terminal 83, which is connected to the LAN (see FIG. 1) via a LAN cable 77.

The peg portion 81 is also provided with a plurality of detection portions, here, 85A, 85B, and 85C. The detection portions 85A to 85C are sensors configured to detect that a wind instrument such as the trumpet 75 is put on the peg portion 81. The detection portions 85A to 85C are, for example, relay switches that switch between on and off by the placing of a wind instrument on the peg portion 81. For instance, the detection portions 85A to 85C are all in an off state when no wind instrument is on the peg portion 81.

The detection portions 85A to 85C are provided at different points along a top-bottom direction of the peg portion 81. In the configuration of FIG. 9, the detection portion 85A, the detection portion 85B, and the detection portion 85C are mounted in this order from the top downward. When the trumpet 75 or another wind instrument that has a different inner bell diameter is put on the peg portion 81, the plurality of detection portions, here, 85A to 85C, output detection signals different from one another, details of which are described later.

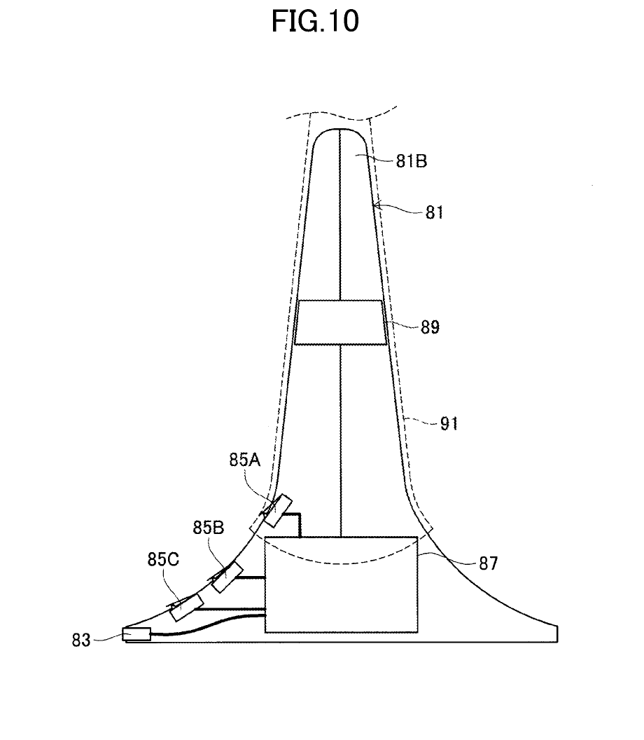

FIG. 10 is an internal structural diagram of the peg portion 81. An amplifier 87 and a vibrator 89 are mounted to the inside of the peg portion 81. The amplifier 87 is mounted to a lower part of the inside of the peg portion 81 to amplify the music data MD supplied from the smartphone 13 and output the amplified data to the vibrator 89. The vibrator 89 is mounted to an upper part of the inside of the peg portion 81 so that the outer circumferential surface of the vibrator 89 is in contact with the casing of the peg portion 81, and the vibration of the vibrator 89 vibrates the peg portion 81.

FIG. 11 is a view of the stand 73 with the trumpet 75 put thereon. When the trumpet 75 is put on the peg portion 81, the detection portions 85A to 85C are all switched on from an off state at the contact of the bell 75A with the peg portion 81. In response to the detection signals input from the detection portions 85A to 85C, the amplifier 87 notifies information about the switched on detection portions 85A to 85C to the smartphone 13. The smartphone 13 supplies a piece of the music data MD that fits the notification from the amplifier 87 to the wind instrument system 71. The amplifier 87 of the wind instrument system 71 vibrates the vibrator 89 in a manner that is determined by the piece of the music data MD supplied from the smartphone 13, thereby vibrating the peg portion 81 and the trumpet 75 and causing the trumpet 75 to generate sound.

When the trumpet 75 is put on the peg portion 81, a part of the bell 75A comes into contact with the peg portion 81, and the vibration of the vibrator 89 is accordingly transmitted to the entirety trumpet 75 including its bell 75A and pipe, thereby vibrating the entirety of this musical instrument. The vibration is also transmitted to the air inside the pipe, causing the interior of the pipe to resonate. The musical instrument is thus utilized as a vibrating body and a resonator, and sound is emitted as a result. Resonant frequency characteristics vary from one type of wind instrument to another. A sound that has characteristics unique to the musical instrument put on the peg portion 81 is therefore emitted.

The smartphone 13 supplies to the wind instrument system 71 apiece of the music data MD that fits the specifics of the notification from the amplifier 87. Specifically, when the trumpet 75 is put on the peg portion 81 and the detection portions 85A to 85C are consequently all switched on as described above, the smartphone 13 detects that all three of the detection portions 85A to 85C are on and supplies, for example, a piece of the music data MD that is suitable to the resonant frequency characteristics of the trumpet 75 to the wind instrument system 71.

The smartphone 13 supplies a varying piece of the music data MD depending on which of the detection portions 85A to 85C is switched on. For example, when a wind instrument 91 (e.g., clarinet) smaller in inner bell diameter than the trumpet 75 is put on the peg portion 81 as indicated by the broken line in FIG. 10, the wind instrument 91 rests at a higher point on the peg portion 81 than the trumpet 75 does because the wind instrument 91 has a bell smaller than the bell 75A of the trumpet 75. Consequently, for example, only the detection portion 85A, which is at the highest point on the peg portion 81 out of the three detection portions 85A to 85C, is switched on. The smartphone 13 in this case detects that only the detection portion 85A is on based on the notification from the wind instrument system 71, and supplies, for example, a piece of the music data MD that is suitable to the resonant frequency characteristics of clarinets to the wind instrument system 71. Alternatively, the smartphone 13 may change the frequency characteristics of a piece of the music data MD that is being supplied to those suitable to the resonant frequency characteristics of the wind instrument or the like instead of switching to a piece of the music data MD of a different type. The smartphone 13 may thus supply the wind instrument system 71 with a piece of the music data MD that is suitable to the resonant frequency characteristics of a wind instrument put on the stand 73 and make the wind instrument resonate in a favorable manner, thereby causing the wind instrument to generate a sound.

The detection portions 85A to 85C are not limited to relay switches, and may be any other detection mechanisms capable of detecting the placing of the trumpet 75 or another musical instrument on the stand 73, for example, photoelectric sensors or load sensors. While relay switches are used in the example given above to detect features of a musical instrument (the size, the inner diameter, and the like of the bell 75A), the method of detection is not limited thereto. For example, the resonant frequency characteristics or the like of a wind instrument put on the peg portion 81 may be determined by providing the peg portion 81 with a vibration pickup and detecting how the wind instrument vibrates in response to vibration given by the vibrator 89. The resonant frequency characteristics or the like of the wind instrument may also be detected by mounting a speaker and a microphone to the peg portion 81 and detecting the resonance of a sound that is collected with the microphone while varying the frequency characteristics of a sound that is generated from the speaker. The equipment that is provided with the detection portions 85A to 85C is not limited to the stand 73 for a wind instrument. Equipment that holds a musical instrument of a different type, for example, the stand 41 (see FIG. 3) for the guitar 43 in the embodiment described above may be provided with a plurality of relay switches, photoelectric sensors, load sensors, or the like to detect whether or not the string instrument is on the equipment and the type of the string instrument (a guitar, a bass guitar, or the like).

The smartphone 13 may vibrate the peg portion 81 with the use of the vibrator 89 to generate a sound by switching to another piece of the music data MD or changing the frequency characteristics of the current piece of the music data MD in response to the detection of the taking of the trumpet 75 off the peg portion 81. For example, in the case where the user takes the trumpet 75 off while music is being played, there is a chance that power is unnecessarily consumed by the vibration operation of the vibrator 89 that continues despite the absence of the trumpet 75 on the peg portion 81. There is also a case where the peg portion 81 without the trumpet 75 put thereon just vibrates in a manner determined by the resonant frequency characteristics of the trumpet 75, and no sound is generated. The user in that case may not realize that the amplifier 87 and the vibrator 89 are in operation.

Accordingly, when detecting that the trumpet 75 is taken off the peg portion 81, thereby switching off all of the detection portions 85A to 85C, during, for example, the reproduction of a piece of the music data MD, the smartphone 13 supplies the wind instrument system 71 with a piece of the music data MD that has frequency characteristics resonant with the peg portion 81. The peg portion 81 of FIG. 10 has a conical shape that is hollow and, when, for example, the vibration of the built-in vibrator 89 is increased in amplitude or reduced in cycle, the vibration causes a collision between components of the stand 73 or other phenomena that generate sound. The smartphone 13 may thus inform the user that the trumpet 75 has been taken off of the stand 73 during the operation of the wind instrument system 71 by making, in response to the taking off of the trumpet 75, a change to the music data MD in a manner that generates a strange sound irrelevant to music from the peg portion 81. Once being aware of the strange sound, the user may take an appropriate action such as returning the trumpet 75 on the peg portion 81 or operating the smartphone 13 so as to stop the supply of the music data MD to the wind instrument system 71.

When an output device (the TA piano 21 or others) that is in a state where the music data MD cannot be reproduced is detected (S25 of FIG. 5: NO), the smartphone 13 in the embodiment described above automatically executes the processing of stopping the supply of the music data MD to the output device currently incapable of music data reproduction (S27) and other procedures. The smartphone 13 may instead inform the user of the result of the state detection to receive an operation instruction from the user.

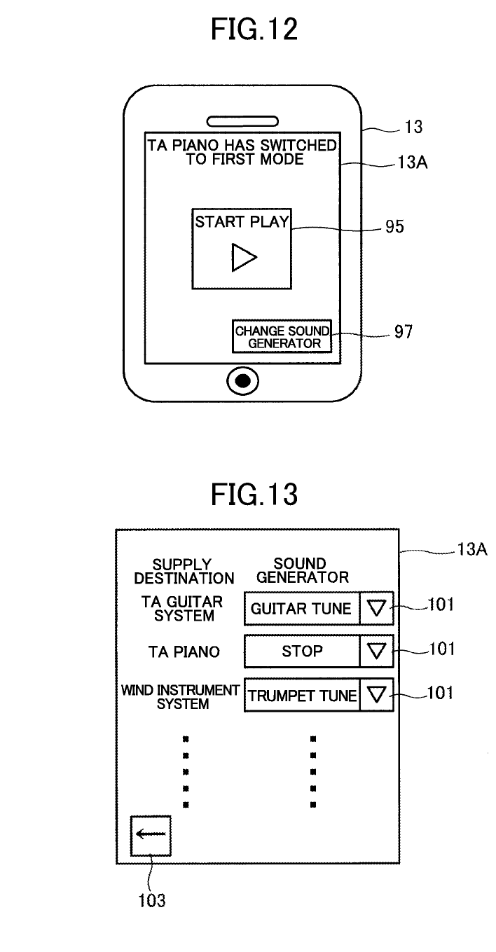

FIG. 12 is an example of a display screen of the smartphone 13 that is displayed when a change in state is detected. Instead of automatically switching the output device in S27 in the embodiment described above, for example, the smartphone 13 displays in an upper part of the touch panel 13A a message to the effect that “the TA piano 21 has switched to the first mode” to notify the user that a change in the state of the TA piano 21 has been detected. A play button 95 is displayed in a central portion of the touch panel 13A. The play button 95 is touched by the user to continue playing at the changed settings. In the case where the user does not execute sound generator selection, which is described later, and touches the play button 95, the smartphone 13 continues playing at recommended settings that are suited to the results of detection by the detection module 39 and others. For example, when the TA piano 21 switches to the first mode, the smartphone 13 sets, as the recommended settings for this case, settings that stop the supply of the music data MD to the TA piano 21 and that use another output device to continue the playing of music.

A sound generator changing button 97 with which the user selects a sound generator is displayed in a lower part of the touch panel 13A. The smartphone 13 displays a screen illustrated in FIG. 13 on the touch panel 13A when the user touches the sound generator changing button 97. As illustrated in FIG. 13, the names of output devices (supply destinations) to which the music data MD is output are displayed vertically one after another on the left hand side of the screen of the touch panel 13A, and the types (sound generators) of the music data MD supplied to the respective output devices are displayed on the right hand side of the screen. For example, a selection button 101 is displayed to the right of a field where “stop” is displayed as a sound generator associated with the TA piano 21. This selection button 101 is a button for switching the sound generator that is supplied to the TA piano 21 (an output device). When the user touches the selection button 101, the smartphone 13 displays sound generators (a guitar tune, a piano tune, a trumpet tune, and a clarinet tune) relevant to a piece of the music data MD that is being reproduced so that a sound generator can be selected from a pull-down menu. Alternatively, the smartphone 13 may display, at the touch of the selection button 101, on the touch panel 13A, a screen (fader or the like) in which a piece of the music data MD to be supplied to the TA piano 21 can be changed in volume or can be processed by equalizing, for example.

In the case where a clarinet instead of the trumpet 75 is put on the stand 73 in the wind instrument system 71 of FIG. 8 to FIG. 11, for example, the smartphone 13 performs control that supplies a clarinet tune to the wind instrument system 71 at the recommended settings described above. In the case where the user wishes to supply a trumpet tune to the wind instrument system 71, on the other hand, the sound generator for the wind instrument system 71 can be changed to a trumpet tune by selecting the selection button 101 of the corresponding sound generator for the wind instrument system 71 on the screen of FIG. 13. After changing the sound generator, the user touches a back button 103, which is displayed in a lower left corner of the touch panel 13A of FIG. 13, to return to the screen of FIG. 12, and then touches the play button 95 to continue playing at the changed settings. With this configuration, the user may switch the destination to which the music data MD is supplied, or switch the sound generator to be supplied, or make other changes depending on the state of the output devices by operating the smartphone 13.

The user may check the wind instrument installation state by checking what is displayed on the touch panel 13A of FIG. 12. For example, in the case where a trumpet tune is set as the sound generator despite the fact that a clarinet has been put on the stand 73 of the wind instrument system 71, the user may recognize from information displayed on the touch panel 13A that the wind instrument may not be installed properly (put at an angle or the like).

FIG. 12 and FIG. 13 deal with a case where the user selects a sound generator in response to a change in the state of an output device during playing. The acoustic system may instead be configured so that the user can select a sound generator before playing. Specifically, while the smartphone 13 in the embodiment described above analyzes the frequency characteristics of a piece of the music data MD selected by the user (S19) and automatically chooses an output device that is to reproduce the piece of the music data MD (S21) as illustrated in FIG. 4, the screens of FIG. 12 and FIG. 13 may be displayed on the touch panel 13A to allow the user to select a sound generator.

In the embodiment described above, whether or not the music data MD is to be supplied is set to each control unit (e.g., the control unit 17A) under control of the smartphone 13. Alternatively, the control unit 17A and other control units may have a function of determining whether or not the music data MD is to be supplied depending on the characteristics of their associated output devices.

For example, when the user selects a tune, the smartphone 13 performs control that supplies the selected piece of the music data MD from the music data supplying device 11 to all output devices connected to the LAN (the speaker device 17, the TA piano 21, and others), which means that each output device on the network receives the same data. The control unit 21A, for example, receives out of the received music data MD a piece of the music data MD that has frequency characteristics suitable to the vibration characteristics of the soundboard 33 of the TA piano 21. The control unit 21A may instead analyze the frequency characteristics of the received piece of the music data MD to extract only a necessary frequency component. The control unit 21A may be configured so as to include, for example, a filter or an equalizer to execute processing of extracting only a frequency component suitable to the vibration characteristics of the soundboard 33, enhancing processing, decreasing processing, or the like. In this configuration, the control unit 17A or other control units on the output device side executes processing of determining whether or not the packet P of the music data MD supplied to the LAN is suitable for the output device. This eliminates the need for the smartphone 13 to determine to which output device the music data MD is to be supplied, and the smartphone 13 only needs to perform control that broadcasts the music data MD to every output device on the LAN. The acoustic system 10 may also be configured so that the music data supplying device 11 is operated to broadcast the same piece of the music data MD to all output devices and so that the output device side executes the necessary extraction processing on the piece of the music data MD. The acoustic system 10 in this case may not include the smartphone 13.

The control unit 17A and other control units may each determine whether to supply a piece of the music data MD to the output device that is associated with the control unit by, for example, analyzing the frequency of the piece of the music data MD contained in the packet P, or processing data that is set to the packet P (e.g., information about an output device to which the packet P is to be supplied). For example, a multi-track file in which a flag value indicating the tone timbre or the frequency characteristics (an identifier identifying data for a piano, data for a guitar, or the like) is attached to each track may be used as the music data MD. The flag value may be set in advance by, for example, a vendor that runs a music distribution business. Alternatively, a unique flag value may be set to each track of the music data MD so that the smartphone 13 analyzes the frequency characteristics of the track for determination on the output device side. The output device side, for example, the control unit 21A of the TA piano 21, may receive the packet P of the music data MD supplied to the LAN and, when the music data MD includes a track to which a flag value for a piano is set, supply to the vibrator 31 drive signals converted from data of this track. In short, each control unit on the output device side may determine whether or not the music data MD is necessary based on the flag value that reflects the frequency characteristics. In this configuration also, the smartphone 13 does not need to determine the destination to which the music data MD is supplied and only needs to broadcast the same multi-track music data MD to every output device on the LAN. The acoustic system. 10 in this case has no need for control by the smartphone 13, and can omit the smartphone 13.

Alternatively, the control unit 17A and other control units may each determine whether to supply the music data MD to the output device that is associated with the control unit based on the user's operation instruction. For example, whether to supply the music data MD to the TA piano 21 may be changed by the user by operating the operation portion 35 (see FIG. 2). In this case, for example, when the tune to be played by the acoustic system 10 is a piano tune, the user can set the TA piano 21 so that the music data MD of the packet P received by the TA piano 21 is reproduced in the TA piano 21 by operating the operation portion 35 and other components of the TA piano 21 in advance.

An acoustic system according to the technology disclosed in this patent application includes, for example: a supply device, which is connected to a network and configured to supply an acoustic signal to the network; at least one output device configured to output a sound that is based on the acoustic signal supplied from the supply device via the network; a detection portion configured to detect whether the at least one output device is in a state of being capable of outputting the sound; and a control device configured to control, based on a result of the detection by the detection portion, to which output device the acoustic signal is to be supplied out of the at least one output device. The acoustic signal here is, for example, an audio signal or music playing performance data (acoustic signals converted from music playing event data such as MIDI data).

In this acoustic system, the detection portion detects whether an output device is in a state of being capable of outputting a sound. The detection portion notifies the control device that an output device is in a state of being incapable of outputting a sound when, for example, detecting that the output device is in a mode where a supplied acoustic signal cannot be output, or that the output device is powered off. The control device controls to which output device an acoustic signal is to be supplied based on the detection result of the detection portion. The acoustic system may thus stop the supply of an acoustic signal to an output device depending on the state of the output device.

In the acoustic system according to the technology disclosed in this patent application, the control device may be further configured to set to which output device the acoustic signal is to be supplied based on the detection result of the detection portion.

In this acoustic system, the control device may switch the destination to which an acoustic signal is to be supplied from, for example, an output device that has become incapable of outputting sound due to a change in state to another output device.

In the acoustic system according to the technology disclosed in this patent application, the control device may be further configured to change frequency characteristics of the acoustic signal depending on the detection result of the detection portion.

In this acoustic system, the detection portion monitors, for example, an output device that includes a vibrated body (a soundboard of a piano, a bell of a trumpet, or the like) and a vibrator configured to vibrate the vibrated body, and detects the vibration characteristics or the like of the soundboard or the bell. The control device in this case may set appropriate frequency characteristics based on the vibration characteristics or the like of the vibrated body as the frequency characteristics of an acoustic signal to be supplied to an output device whose state has been detected by the detection portion.

In the acoustic system according to the technology disclosed in this patent application, the control device may be further configured to inform a user of the detection result of the detection portion, and receive an operation instruction of the user in response.

In this acoustic system, the user may switch the output device to which an acoustic signal is to be supplied or make other changes depending on the state of the output device by, for example, operating the control device.

In the acoustic system according to the technology disclosed in this patent application, the at least one output device may include a vibrator configured to vibrate in a manner determined by the acoustic signal, and a vibrated body configured to output the sound based on the vibration of the vibrator, and the detection portion may be further configured to detect whether or not the output device including the vibrated body and the vibrator is in a state of being capable of outputting the sound by causing the vibrator to operate, and notify a result of the detection to the control device.

In this acoustic system, the detection portion monitors, for example, a musical instrument (output device) that includes a soundboard (vibrated body) and a vibrator to detect whether the current mode is one in which the output device is used as a normal musical instrument or one in which the output device emits sound by causing the vibrator to operate. When detecting the mode in which the output device is used as a normal musical instrument, for example, the detection portion notifies the control device that the output device is in a state of being capable of outputting the sound (the output device does not need to be supplied with an acoustic signal). The acoustic system may thus switch the output device to which an acoustic signal is to be supplied depending on the state of output devices that include a vibrator among others.

In the acoustic system according to the technology disclosed in this patent application, the at least one output device may include a holding portion, which is provided with the vibrator and configured to hold the vibrated body, and the control device may be further configured to supply, when detecting from the detection result of the detection portion that the vibrated body has been taken off the holding portion of the output device to which the acoustic signal is supplied, a vibration signal with which the vibrator vibrates the holding portion, as the acoustic signal to be supplied to the output device in which the vibrated body has been taken off the holding portion.

When the vibrated body is taken off the holding portion, the control device in this acoustic system may generate a sound by supplying a vibration signal and vibrating the holding portion with the use of the vibrator. The vibration signal here may be a signal prepared separately from an acoustic signal, or may be a signal created by changing the frequency characteristics of an acoustic signal that is being supplied. This enables the acoustic system to generate, from a stand provided with the vibrator, a sound irrelevant to music that is being played when, for example, a guitar is taken off the stand. Hearing this sound, the user may realize that the guitar has been taken off while the vibrator is in operation, and take an appropriate action such as returning the guitar on the stand or stopping the operation of the vibrator. In addition, because the sound is generated by vibrating the stand with the use of the vibrator, there is no need to separately provide a buzzer, a lamp, or the like for alerting to an error.

The technology disclosed in this patent application may provide, for example, the acoustic system capable of switching from one of output devices that are connected to a network to another as a destination to which an acoustic signal is to be supplied.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An acoustic system, comprising:
a supply device, which is connected to a network and configured to supply an acoustic signal to the network;
at least one output device configured to output a sound that is based on the acoustic signal supplied from the supply device via the network;
a detection unit configured to detect whether the at least one output device is in a state of being capable of outputting the sound; and
a control device configured to control, based on a result of the detection by the detection unit, to which output device the acoustic signal is to be supplied out of the at least one output device.

2. The acoustic system according to claim 1, wherein the control device is further configured to set to which output device the acoustic signal is to be supplied based on the detection result of the detection unit.

3. The acoustic system according to claim 2, wherein the control device is further configured to change frequency characteristics of the acoustic signal depending on the detection result of the detection unit.

4. The acoustic system according to claim 2, wherein the control device is further configured to inform a user of the detection result of the detection unit, and receive an operation instruction of the user in response.

5. The acoustic system according to claim 1,
wherein the at least one output device comprises a vibrator configured to vibrate in a manner determined by the acoustic signal, and a vibrated body configured to output the sound based on the vibration of the vibrator, and
wherein the detection unit is further configured to detect whether or not the output device comprising the vibrated body and the vibrator is in a state of being capable of outputting the sound by causing the vibrator to operate, and notify a result of the detection to the control device.

6. The acoustic system according to claim 5,
wherein the at least one output device comprises a holding unit, which is provided with the vibrator and configured to hold the vibrated body, and
wherein the control device is further configured to supply, when detecting from the detection result of the detection unit that the vibrated body has been taken off the holding unit of the output device to which the acoustic signal is supplied, a vibration signal with which the vibrator vibrates the holding unit, as the acoustic signal to be supplied to the output device in which the vibrated body has been taken off the holding unit.

7. The acoustic system according to claim 3, wherein the control device is further configured to inform a user of the detection result of the detection unit, and receive an operation instruction of the user in response.

8. The acoustic system according to claim 2,
wherein the at least one output device comprises a vibrator configured to vibrate in a manner determined by the acoustic signal, and a vibrated body configured to output the sound based on the vibration of the vibrator, and
wherein the detection unit is further configured to detect whether or not the output device comprising the vibrated body and the vibrator is in a state of being capable of outputting the sound by causing the vibrator to operate, and notify a result of the detection to the control device.

9. The acoustic system according to claim 3,
wherein the at least one output device comprises a vibrator configured to vibrate in a manner determined by the acoustic signal, and a vibrated body configured to output the sound based on the vibration of the vibrator, and
wherein the detection unit is further configured to detect whether or not the output device comprising the vibrated body and the vibrator is in a state of being capable of outputting the sound by causing the vibrator to operate, and notify a result of the detection to the control device.

10. The acoustic system according to claim 4,
wherein the at least one output device comprises a vibrator configured to vibrate in a manner determined by the acoustic signal, and a vibrated body configured to output the sound based on the vibration of the vibrator, and
wherein the detection unit is further configured to detect whether or not the output device comprising the vibrated body and the vibrator is in a state of being capable of outputting the sound by causing the vibrator to operate, and notify a result of the detection to the control device.

11. The acoustic system according to claim 8,
wherein the at least one output device comprises a holding unit, which is provided with the vibrator and configured to hold the vibrated body, and
wherein the control device is further configured to supply, when detecting from the detection result of the detection unit that the vibrated body has been taken off the holding unit of the output device to which the acoustic signal is supplied, a vibration signal with which the vibrator vibrates the holding unit, as the acoustic signal to be supplied to the output device in which the vibrated body has been taken off the holding unit.

12. The acoustic system according to claim 9,
wherein the at least one output device comprises a holding unit, which is provided with the vibrator and configured to hold the vibrated body, and
wherein the control device is further configured to supply, when detecting from the detection result of the detection unit that the vibrated body has been taken off the holding unit of the output device to which the acoustic signal is supplied, a vibration signal with which the vibrator vibrates the holding unit, as the acoustic signal to be supplied to the output device in which the vibrated body has been taken off the holding unit.

13. The acoustic system according to claim 10,
wherein the at least one output device comprises a holding unit, which is provided with the vibrator and configured to hold the vibrated body, and
wherein the control device is further configured to supply, when detecting from the detection result of the detection unit that the vibrated body has been taken off the holding unit of the output device to which the acoustic signal is supplied, a vibration signal with which the vibrator vibrates the holding unit, as the acoustic signal to be supplied to the output device in which the vibrated body has been taken off the holding unit.

14. The acoustic system according to claim 1, wherein the supply device is further configured to broadcast the same acoustic signal to all of the at least one output device.

15. The acoustic system according to claim 1, wherein the control device comprises a smartphone.

16. The acoustic system according to claim 1, wherein the at least one output device comprises one of a speaker device, a player piano, a TA piano, and a TA guitar system.

17. An acoustic system control device, comprising:
an acoustic signal obtaining unit configured to obtain an acoustic signal;
an optimum frequency characteristics obtaining unit configured to obtain, from each of a plurality of output devices each configured to output a sound based on the acoustic signal, optimum frequency characteristics of the each of a plurality of output devices;
an output feasibility information obtaining unit configured to obtain output feasibility information, which indicates whether or not at least one of the plurality of output devices is in a state of being capable of outputting the sound; and
a selection unit configured to select, from among the plurality of output devices, based on the acoustic signal, the optimum frequency characteristics, and the output feasibility information, at least one output device to which the acoustic signal is to be output.

18. The acoustic system control device according to claim 17, wherein the acoustic signal is obtained from a supply device, which is connected via a network.

19. The acoustic system control device according to claim 17, wherein the selection unit is further configured to select the at least one output device based on a selection that is made in the past with respect to the acoustic signal.

20. An acoustic system control method, comprising:
supplying an acoustic signal to the network by a supply device, which is connected to a network;
outputting a sound that is based on the acoustic signal supplied from the supply device via the network by at least one output device;
detecting whether the at least one output device is in a state of being capable of outputting the sound by a detection unit; and
controlling, based on a result of the detection by the detection unit, to which output device the acoustic signal is to be supplied out of the at least one output device, by a control device.
